(19) United States
(12) Patent Application Publication
(10) Pub. No.: US 2021/0321062 A1
(43) Pub. Date: Oct. 14, 2021

(54) IMAGE PROCESSING DEVICE IN MOVING OBJECT, IMAGING DEVICE, IMAGE PROCESSING METHOD, AND RECORDING MEDIUM

(71) Applicant: CANON KABUSHIKI KAISHA, Tokyo (JP)

(72) Inventor: Taisei Mori, Kanagawa (JP)

(21) Appl. No.: 17/222,410

(22) Filed: Apr. 5, 2021

(30) Foreign Application Priority Data
Apr. 14, 2020 (JP) 2020-072257

(51) Int. Cl. H04N 7/18; G06K 9/00; G06T 11/00; B60R 1/00; H04N 5/272; G01C 3/00; G01S 17/08

(52) U.S. Cl. CPC H04N 7/181; G06K 9/00825; G06K 9/00362; G06T 11/00; B60R 2300/301; H04N 5/272; G01C 3/00; G01S 17/08; B60R 2300/8093; B60R 1/00

(57) ABSTRACT

A vehicle-mounted display device in a moving object displays a video acquired by image capturing performed by an imaging unit on a display unit positioned toward an outer side of the moving object. The vehicle-mounted display device controls superimposed display of a measurement result or an analysis result, related to a subject included in the video displayed on the display unit, on the video.

### BACKGROUND

### Technical Field

One disclosed aspect of the embodiments relates to an image processing device, an imaging device, an image processing method, and a recording medium.

### Description of the Related Art

While driving a vehicle that follows a large-size vehicle, a driver may not be able to ascertain the situation of a field of view blocked by the large-size vehicle. For example, even if a driver desires to pass a preceding large-size vehicle because its traveling speed is slow, the driver's field of view is blocked by the large-size vehicle and the driver cannot confirm whether there is a preceding vehicle in front of the large-size vehicle, and therefore the passing is not possible. In addition, the blockage of the field of view delays the detection of pedestrians appearing in front of the large-size vehicle, which may lead to an accident. Japanese Patent Laid-Open No. 2002-166750 discloses a vehicle that displays a video captured by a camera installed in front of the vehicle in its traveling direction on a display installed behind the vehicle.

According to the vehicle disclosed in Japanese Patent Laid-Open No. 2002-166750, a following vehicle only recognizes a video displayed on the display of a preceding vehicle, and therefore it is not possible to ascertain a forward situation more accurately than in the case of visual observation. For example, from the video reflected in the display, it is not possible to accurately ascertain a distance between the large-size vehicle and a vehicle preceding it, or to know whether there is sufficient space for a host vehicle to enter in front of the large-size vehicle. In addition, if a pedestrian appears in front of the large-size vehicle and the pedestrian is reflected small in the display, a driver of the following vehicle is not aware of the pedestrian and cannot drive safely. Meanwhile, moving objects such as a ship or an aircraft as well as a vehicle may not be able to accurately ascertain a forward situation from a video. In addition, circumstances in which a forward situation is not able to be accurately ascertained from a video may occur even if the following vehicle is driven automatically.

### SUMMARY

One aspect of the embodiments is a device that displays a captured video on a display device installed toward the outer side of a moving object, and provides an image processing device capable of allowing other moving objects to accurately ascertain the situation of a subject within a video.

According to an embodiment, an image processing device provided in a moving object, including at least one processor and a memory holding a program which makes the processor function as a display control unit and a control unit. The display control unit is configured to be provided or positioned toward an outer side of the moving object to display a video acquired by image capturing performed by an imaging unit provided or positioned in the moving object on a display device. The control unit is configured to control superimposed display of a measurement result or an analysis result related to a subject included in the video on the video.

Further features of the disclosure will become apparent from the following description of exemplary embodiments with reference to the attached drawings.

### BRIEF DESCRIPTION OF THE DRAWINGS

FIG. 1 is a diagram illustrating a configuration of an image processing device.

FIG. 2 is a diagram illustrating an outward appearance seen from in front of a vehicle in which a vehicle-mounted display device is mounted.

FIG. 3 is a diagram illustrating a display example of a video based on the vehicle-mounted display device.

FIGS. 4A and 4B are flowcharts illustrating an operation process of the vehicle-mounted display device.

FIG. 5 is a flowchart illustrating the operation process of the vehicle-mounted display device.

FIG. 6 is a diagram illustrating an example of superimposed display in which a traffic light is highlighted.

FIG. 7 is a diagram illustrating an example of superimposed display in which a pedestrian is highlighted.

FIG. 8 is a diagram illustrating an example of an outward appearance seen from the lateral side of the vehicle.

FIG. 9 is a diagram illustrating an example of a situation in which superimposed display is performed.

FIGS. 10A and 10B are flowcharts illustrating the operation process of the vehicle-mounted display device.

FIG. 11 is a flowchart illustrating the operation process of the vehicle-mounted display device.

### DESCRIPTION OF THE EMBODIMENTS

### Example 1

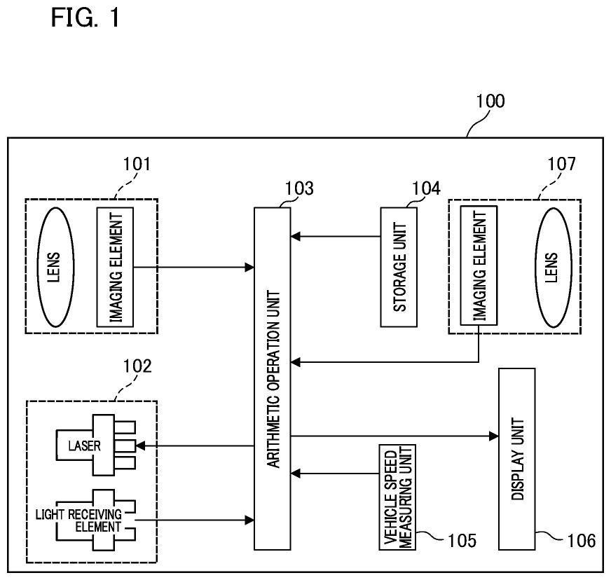

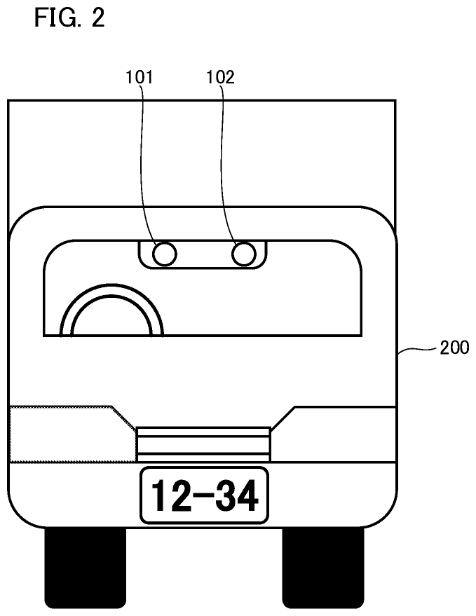

FIG. 1 is a diagram illustrating a configuration of an image processing device of the present embodiment. In addition, FIG. 2 shows an outward appearance seen from in front of a vehicle in which a vehicle-mounted display device is mounted. Hereinafter, the present embodiment will be described with reference to the accompanying drawings. Meanwhile, the same reference numbers shown in different drawings indicate the same components.

A vehicle-mounted display device 100 is an example of an image processing device provided, placed, positioned, located, or disposed in a vehicle 200 which is an example of a moving object. The vehicle-mounted display device 100 also functions as an imaging device. The vehicle 200 is a large-size vehicle such as, for example, a truck or a bus. Meanwhile, a moving object to which the disclosure can be applied is not limited to a vehicle. The disclosure can be applied to at least any of a vehicle, a ship, or an aircraft.

In the example shown in FIG. 1, the vehicle-mounted display device 100 includes an imaging unit 101, a distance measuring unit 102, an arithmetic operation unit 103, a storage unit 104, a vehicle speed measuring unit 105, a display unit 106, and an imaging unit 107. The imaging units 101 and 107 acquire a video through image capturing. For this, each of the imaging units 101 and 107 has a lens and an imaging element. The lens condenses subject light to create an optical image on the imaging element. The imaging element converts the optical image into an electronic image to output video data. For example, the imaging unit 101 captures an image of a region in the traveling direction (forward direction) of the vehicle 200 to acquire a video. In addition, the imaging unit 107 captures an image of a region in a direction different from the traveling direction of the vehicle 200 to acquire a video. For example, the imaging unit 107 captures an image of a region behind the vehicle 200 to acquire a video. Meanwhile, depending on the embodiment, it may be arbitrarily determined in which direction the imaging units 101 and 107 acquire a video of a region. For example, the imaging unit 101 may capture an image of a region in front of the vehicle 200 to acquire a video, and the imaging unit 107 may capture an image of a region in a lateral direction (a leftward direction or a rightward direction) of the vehicle 200 to acquire a video.

The distance measuring unit 102 has a laser irradiation unit and a light receiving element, and measures a distance between the vehicle 200 and a subject through active distance measurement. The measured distance corresponds to the depth (depth information) of the subject in its depth direction. Specifically, the laser irradiation unit performs irradiation with laser, and light reflected from the subject is received by the light receiving element. The distance measuring unit 102 measures a distance from the vehicle 200 to the subject by measuring a time from laser irradiation to light reception. The subject is, for example, a vehicle preceding the vehicle 200, an oncoming vehicle, a point of intersection located in front, a traffic light, a person (for example, a pedestrian), or the like.

Examples of the above-described depth information include a map of the amount of image shift and a map of the amount of defocus. The map of the amount of image shift is calculated from a plurality of viewpoint images having different viewpoints, and the map of the amount of defocus is calculated by multiplying the amount of image shift by a predetermined conversion coefficient. Therefore, instead of the distance measuring unit 102, the arithmetic operation unit 103 may calculate a distance to the subject on the basis of the amount of parallax between a plurality of captured images having different viewpoints. For this, for example, the imaging unit 101 may be a stereo camera having a plurality of combinations of a lens and an imaging unit. The arithmetic operation unit 103 measures a distance based on the amount of parallax between images obtained by image capturing performed by a stereo camera, so that it is possible to omit the distance measuring unit 102 and to realize an inexpensive and simple configuration.

In addition, it is possible to calculate a distance to the subject by applying a self-position/posture estimation technique and estimating the three-dimensional position of the subject and the position of the camera (the imaging unit 101) using a monocular camera. For example, the arithmetic operation unit 103 uses two images having different image capturing times to calculate a distance to the subject on the basis of the amount of parallax and the amount of translation of the camera. In addition, if a subject of which the size is already known is reflected in an image, a distance to the subject may be calculated on the basis of the size of the image of the subject.

In addition, the vehicle speed measuring unit 105 measures the speed (vehicle speed) of the vehicle 200. For example, the vehicle speed measuring unit 105 measures the rotational speed of the wheel of the vehicle 200, and converts the measured rotational speed into the vehicle speed of the vehicle 200. Meanwhile, the vehicle speed of the vehicle 200 can also be calculated by calculating a change over time in the position of the camera (the imaging unit 101) obtained by the self-position/posture estimation technique.

The arithmetic operation unit 103 includes a central processing unit or a programmable processor and other devices such as a memory that holds or stores instructions. The instructions, when executed by the processor, cause the processor to perform as various function units described in the following. The arithmetic operation unit 103 controls the entirety of the vehicle-mounted display device 100, and performs image processing, a distance measuring operation, subject recognition, or the like. For example, the arithmetic operation unit 103 controls the display unit 106, and displays a video obtained by the imaging unit 101 on the display unit 106. In addition, the arithmetic operation unit 103 superimposes a measurement result or an analysis result, related to a subject included in the video displayed on the display unit 106, on the video, and displays it on the display unit 106 (superimposedly displays it on the video). The measurement result related to the subject is, for example, a distance between the vehicle 200 and the subject, the speed of the subject, or the like. In addition, the analysis result related to the subject is, for example, the subject being a specific subject determined in advance such as a pedestrian or a traffic light, or the like. In addition, the storage unit 104 is a secondary storage device, and stores data used for processing by the arithmetic operation unit 103 (for example, learned data obtained by machine learning). The storage unit 104 is a secondary storage device, and stores data used for processing by the arithmetic operation unit 103.

The display unit 106 is a display device provided, placed, positioned, located, or disposed in the vehicle 200. The display unit 106 displays a video obtained by the imaging unit 101 in accordance with control of the arithmetic operation unit 103. In addition, the display unit 106 superimposedly displays a measurement result or an analysis result, related to the subject included in the video, on the video in accordance with control of the arithmetic operation unit 103. In the present embodiment, the display unit 106 has a liquid crystal panel. The display unit 106 is installed toward the outer side of the vehicle 200 so that a video can be seen from another vehicle. For example, in order for a video to be able to be seen from a following vehicle, the display unit 106 may be installed behind the outside (for example, the back) of the vehicle 200, or the display unit 106 may be installed at the rear window inside the vehicle 200. In addition, for example, the display unit 106 may be installed as follows so that a video can be seen from another vehicle traveling toward the lateral side of the vehicle 200 on a road intersecting a road on which the vehicle 200 travels. For example, the display unit 106 may be installed on the outer lateral side of the vehicle 200, or may be installed at a window on the inner lateral side of the vehicle 200.

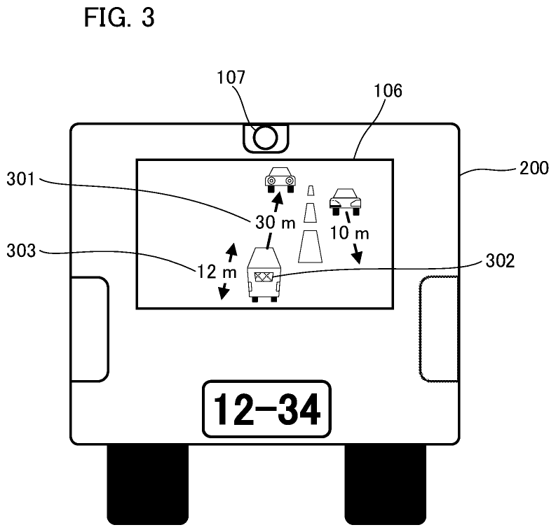

FIG. 3 is a diagram illustrating a display example of a video based on the vehicle-mounted display device. In the example shown in FIG. 3, the vehicle-mounted display device 100 displays a video of a region in front of the vehicle 200 captured by the imaging unit 101 on the display unit 106 provided, placed, positioned, located, or disposed on the back of the vehicle 200, and superimposedly displays a measurement result or an analysis result of a subject within the video on the video. Distance information 301 superimposedly displayed on the video indicates a distance from the vehicle 200 to a preceding vehicle or an oncoming vehicle which is measured by the distance measuring unit 102. In addition, in this example, the arithmetic operation unit 103 of the vehicle-mounted display device 100 also superimposedly displays information relating to the vehicle 200 which is a moving object, on the video, in addition to the measurement result or the analysis result of the subject within the video. The information relating to the vehicle 200 which is superimposedly displayed is, for example, an image 302 of the vehicle 200 and dimensional information (overall length) 303 of the vehicle 200. Meanwhile, in this example, the imaging unit 107 captures an image of a region behind the vehicle 200.

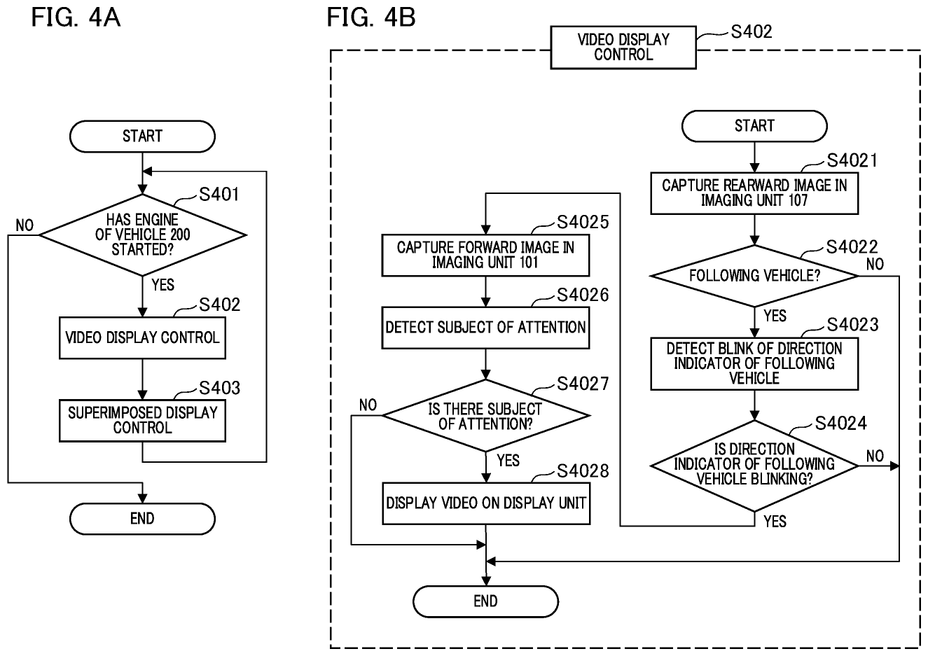

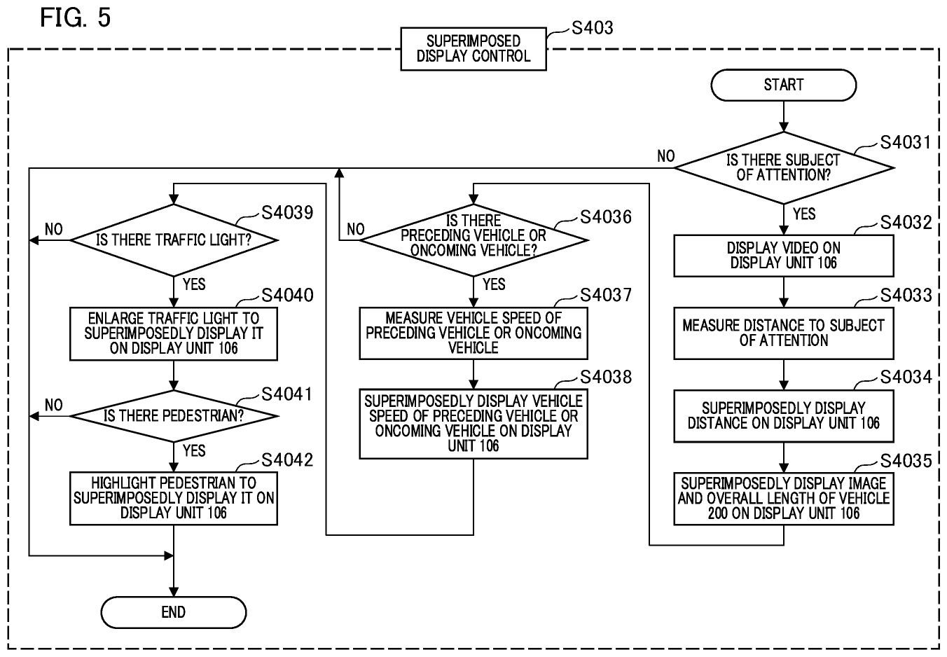

FIGS. 4A to 5 are flowcharts illustrating an operation process of the vehicle-mounted display device of Example 1. In S401 of FIG. 4A, the arithmetic operation unit 103 of the vehicle-mounted display device 100 determines whether the engine of the vehicle 200 has started. If the engine of the vehicle 200 has not started, the process ends. If the engine of the vehicle 200 has started, the process proceeds to S402. Subsequently, in S402, the arithmetic operation unit 103 executes video display control. Specifically, the arithmetic operation unit 103 controls the display unit 106, and displays a video captured by the imaging unit 101. In S403, the arithmetic operation unit 103 executes superimposed display control. Specifically, the arithmetic operation unit 103 superimposedly displays a measurement result or an analysis result of a subject within a video displayed on the display unit 106 on the video. If the video display control is not executed, the superimposed display control is not executed.

FIG. 4B shows an example of the video display control in S402 of FIG. 4A. In S4021, the imaging unit 107 captures an image of a region behind the vehicle 200 to acquire a video. Subsequently, in S4022, the arithmetic operation unit 103 analyzes the video acquired in S4021, and determines whether there is a following vehicle of the vehicle 200 on the basis of the analysis result. If there is no following vehicle, the process ends. If there is a following vehicle, the process proceeds to S4023. In S4023, the arithmetic operation unit 103 analyzes the video acquired in S4021, and executes a process of detecting a blink of the direction indicator of the following vehicle. The arithmetic operation unit 103 detects a blink of the direction indicator using, for example, learned data stored in the storage unit 104. A method of detecting a blink of the direction indicator is not limited to the method of using learned data.

Next, in S4024, the arithmetic operation unit 103 determines whether the direction indicator of the following vehicle is blinking on the basis of the result of the detection process in S4023. If the direction indicator of the following vehicle is not blinking, the process ends. If the direction indicator of the following vehicle is blinking, it means that a driver of the following vehicle intends to pass the vehicle 200. Therefore, in this case, the process proceeds to S4025. Since S4025 and the subsequent steps are executed only when the following vehicle passes the vehicle 200, power consumption can be suppressed. Meanwhile, when it is not necessary to display a live video on the display unit 106, the arithmetic operation unit 103 may display information such as, for example, an advertisement on the display unit 106 during stop. In addition, display of a video may be started or ended in accordance with a traveling time, the weather, or the like. For example, by turning off the display unit 106 during driving at night when it is not necessary to display a video, the driver of the following vehicle can be allowed to travel safely without feeling the glare caused by screen light emission.

Next, in S4025, the imaging unit 101 captures an image of a region in front of the vehicle 200 to acquire a video. In S4026, the arithmetic operation unit 103 analyzes the video acquired in S4025, and executes a process of detecting a subject of attention within the video. In S4027, the arithmetic operation unit 103 determines whether the subject of attention has been detected. The subject of attention is a specific subject determined in advance, and is, for example, a vehicle preceding the vehicle 200, an oncoming vehicle, a pedestrian, a point of intersection, a traffic light, or the like. The preceding vehicle is an example of a moving object that moves the same direction as the traveling direction of the vehicle which is a moving object. In addition, the oncoming vehicle is an example of a moving object that moves in a direction opposite to the traveling direction of the vehicle which is a moving object. The arithmetic operation unit 103 detects a subject of attention using, for example, learned data stored in the storage unit 104. A method of detecting a subject of attention is not limited to the method of using learned data. The arithmetic operation unit 103 may detect a subject of attention using a known pattern matching technique.

If the subject of attention is not detected, the process ends. If the subject of attention has been detected, the process proceeds to S4028. In S4028, the arithmetic operation unit 103 controls the display unit 106, and starts to display a video obtained by image capturing performed by the imaging unit 101. According to the vehicle-mounted display device 100 of the present embodiment, it is possible to control the start or end of display of the video obtained by image capturing performed by the imaging unit 101 on the display unit 106 in accordance with the analysis result of a video obtained by image capturing performed by the imaging unit 107 or the imaging unit 101. Meanwhile, in another embodiment, S4023 and S4024 of FIG. 4B may be omitted, and display of a video may be started in S4028 on condition that a person (for example, a pedestrian) is detected as a subject of attention in S4027.

FIG. 5 is a flowchart illustrating an example of superimposed display control in S403 of FIG. 4A. In S4031, the arithmetic operation unit 103 performs the same process as S4027 of FIG. 4B. That is, the arithmetic operation unit 103 determines whether the subject of attention has been detected from the video obtained by image capturing performed by the imaging unit 101. If the subject of attention is not detected, the process ends. If the subject of attention has been detected, the process proceeds to S4032 and the subsequent steps, and superimposed display of a measurement result or an analysis result of a subject on the video is performed. Thereby, it is possible to control the start or end of the superimposed display control in accordance with the analysis result of the video obtained by image capturing performed by the imaging unit 101.

In S4032, the arithmetic operation unit 103 controls the display unit 106, and displays the video obtained by image capturing performed by the imaging unit 101 on the display unit 106. Thereby, the driver of the following vehicle of the vehicle 200 can know a situation in front of the vehicle 200. Subsequently, in S4033, the distance measuring unit 102 measures a distance from the vehicle 200 to the subject of attention. In S4034, the arithmetic operation unit 103 superimposedly displays information on the distance measured in S4033 on the video. Thereby, for example, the driver of the following vehicle of the vehicle 200 can ascertain whether there is sufficient space for the host vehicle to enter between the vehicle 200 and its preceding vehicle when passing the vehicle 200. In addition, even if the driver performs a lane change to an opposite lane for passing, he or she can know a distance to an oncoming vehicle.

Next, in S4035, the arithmetic operation unit 103 superimposedly displays the image and dimensional information (overall length) of the vehicle 200 stored in advance in the storage unit 104 on the video. Thereby, for example, the driver of the following vehicle of the vehicle 200 can ascertain a distance required to travel in the opposite lane when passing the vehicle 200. The image of the vehicle 200 may be, for example, an image obtained by capturing an image of a vehicle of the same type as the vehicle 200 in advance from the rear, or may be an image of a picture of the vehicle 200 drawn from the rear.

Next, in S4036, the arithmetic operation unit 103 determines whether the subject of attention is a preceding vehicle or an oncoming vehicle. If the subject of attention is neither a preceding vehicle nor an oncoming vehicle, the process ends. If the subject of attention is a preceding vehicle or an oncoming vehicle, the process proceeds to S4037. In S4037, the arithmetic operation unit 103 calculates the vehicle speed of the preceding vehicle or the oncoming vehicle. Specifically, the arithmetic operation unit 103 calculates the vehicle speed of the preceding vehicle or the oncoming vehicle by subtracting the vehicle speed measured by the vehicle speed measuring unit 105 from a change in a distance to the preceding vehicle or the oncoming vehicle acquired at a different time. In S4038, the arithmetic operation unit 103 superimposedly displays the vehicle speed of the preceding vehicle or the oncoming vehicle calculated in S412 on the video. Thereby, for example, a driver of the following vehicle of the vehicle 200 can ascertain whether the following vehicle can travel in the opposite lane with sufficient time until the oncoming vehicle approaches when passing the vehicle 200.

Next, in S4039, the arithmetic operation unit 103 determines whether the subject of attention is a traffic light. If the subject of attention is not a traffic light, the process ends. If the subject of attention is a traffic light, the process proceeds to S4040. In S4040, the arithmetic operation unit 103 highlights the traffic light to superimposedly display it on the video.

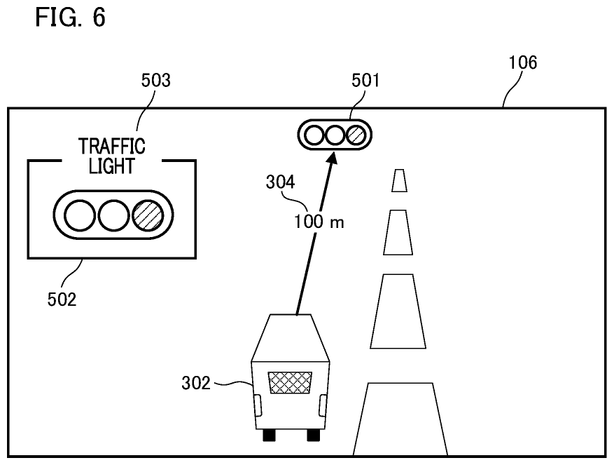

FIG. 6 is a diagram illustrating an example of superimposed display in which a traffic light is highlighted. An enlarged image 502 is an image in which an image 501 of the traffic light is enlarged, and is superimposedly displayed on a video together with the text “TRAFFIC LIGHT” indicating that the enlarged image 502 corresponds to the traffic light. Meanwhile, distance information 304 indicates a distance from the vehicle 200 to the traffic light. The superimposed display as shown in FIG. 6 is performed, so that the driver of the following vehicle can ascertain a signal of a traffic light of the other party in advance, and can rapidly cope with a change in the color of the signal.

FIG. 5 will be described again. In S4041, the arithmetic operation unit 103 determines whether the subject of attention is a person (a pedestrian in this example). If the subject of attention is not a pedestrian, the process ends. If the subject of attention is a pedestrian, the process proceeds to S4042. In S4042, the arithmetic operation unit 103 highlights the pedestrian to superimposedly display it on the video.

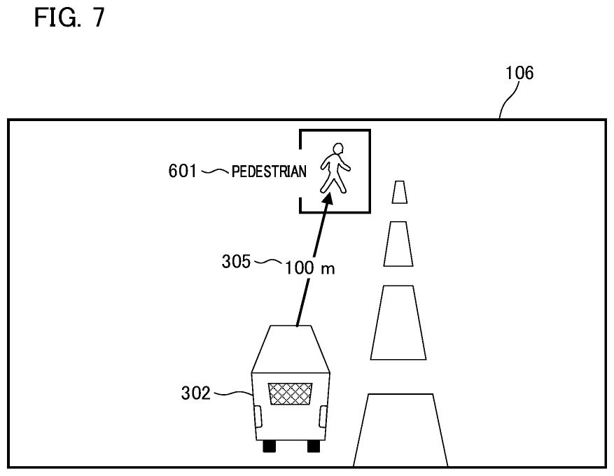

FIG. 7 is a diagram illustrating an example of superimposed display in which a pedestrian is highlighted. In FIG. 7, an image of a pedestrian to which highlighting 601 is added is superimposedly displayed on the video. In this example, the highlighting 601 is display of the test “PEDESTRIAN.” Meanwhile, distance information 305 indicates a distance from the vehicle 200 to the pedestrian. With the display shown in FIG. 7, the driver of the following vehicle of the vehicle 200 can ascertain the existence of the pedestrian in advance and perform safe traveling.

### Example 2

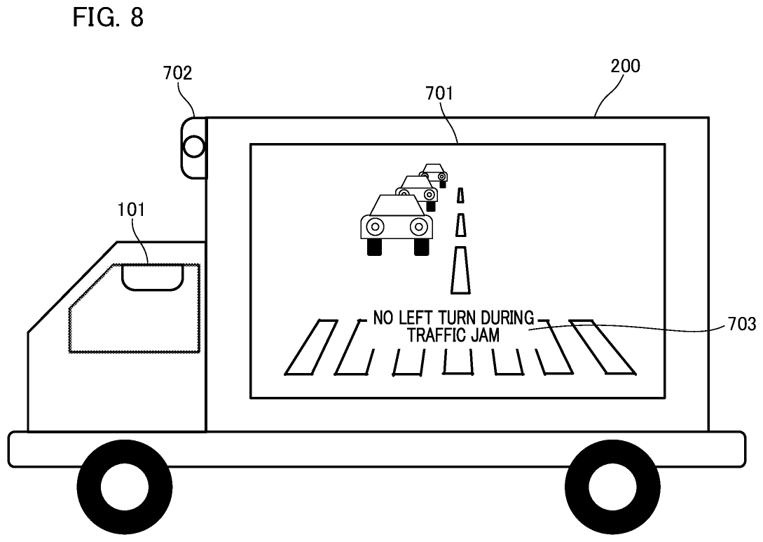

In a vehicle-mounted display device 100 of Example 2, a display unit 701 (FIG. 8) is provided, positioned, located, or disposed on the lateral side of the vehicle 200. The display unit 701 corresponds to the display unit 106 of FIG. 1. The main configuration and function of the vehicle-mounted display device 100 of Example 2 are the same as those of the vehicle-mounted display device 100 described with reference to FIG. 1. In Example 2, since the display unit 701 is located on the lateral side of the vehicle 200, a driver of another vehicle waiting for a left turn or the like to pass through the point of intersection of the vehicle 200 can be allowed to accurately ascertain a situation in front of the vehicle 200, for example, at a point of intersection with a road on which the vehicle 200 travels.

FIG. 8 is a diagram illustrating an example of an outward appearance seen from the lateral side of the vehicle in which the vehicle-mounted display device of Example 2 is mounted. The display unit 701 is provided, placed, positioned, located, or disposed on the lateral side of the vehicle 200, and displays the video obtained by image capturing performed by the imaging unit 101. An imaging unit 702 captures an image of a region in a lateral direction of the vehicle 200. The imaging unit 702 corresponds to the imaging unit 107 of FIG. 1. The arithmetic operation unit 103 (FIG. 1) superimposedly displays a measurement result or an analysis result of a subject within a video displayed on the display unit 701 on the video. Display 703 shown in FIG. 8 is an example of superimposed display of information indicating a state in front of the vehicle 200 and a call for attention on the video. In the example shown in FIG. 8, the display unit 701 is provided, positioned, located, or disposed on the left side of the vehicle 200, but the display unit 701 may be provided, placed, positioned, located, or disposed on both sides.

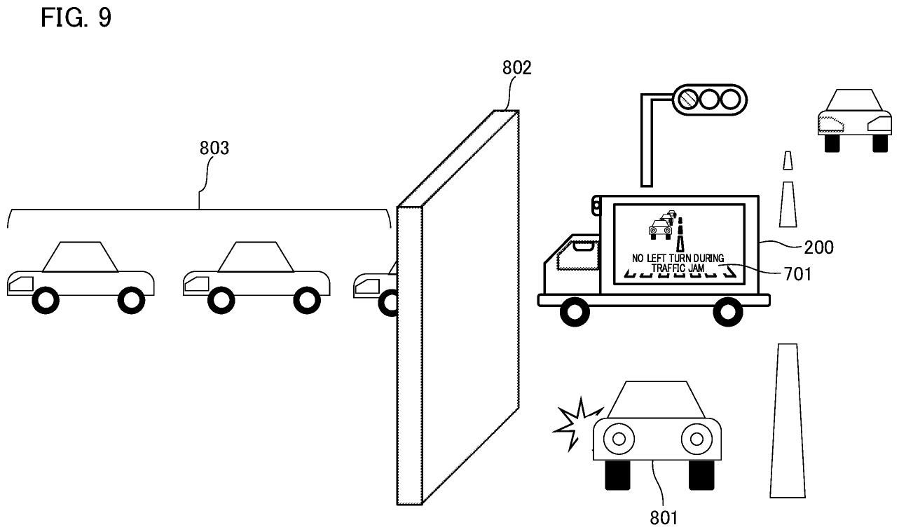

FIG. 9 is a diagram illustrating an example of a situation in which the superimposed display shown in FIG. 8 is performed. The vehicle 200 is about to pass through a point of intersection from a rightward direction to a leftward direction. However, since vehicles 803 stop in the front where the vehicle 200 goes straight and a traffic jam is occurring, the vehicle 200 cannot completely pass through the point of intersection and is traveling slowly in the point of intersection. A vehicle 801 waiting to turn left on an intersecting road blinks the left direction indicator and stops in front of the point of intersection. Since there is an obstacle on the left side of the vehicle 801 to block the field of view in front of the left, and a driver of the vehicle 801 cannot visually confirm the traffic jam caused by the vehicles 803. In the situation as shown in FIG. 9, the vehicle-mounted display device 100 superimposes the state in front of the vehicle 200, that is, the state of a left-turn destination, and information indicating a call for attention on the video obtained by the imaging unit 101 as shown in FIG. 8, and displays it on the display unit 701. Thereby, the driver of the vehicle 801 can recognize the traffic jam of the left-turn destination, and can stop and wait until the traffic jam is alleviated without starting a turn left.

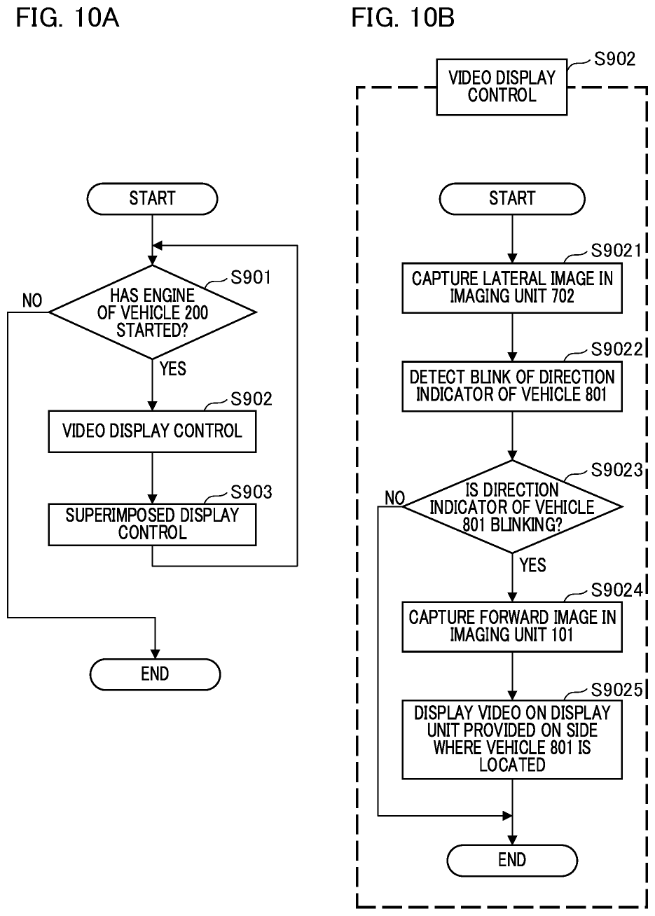

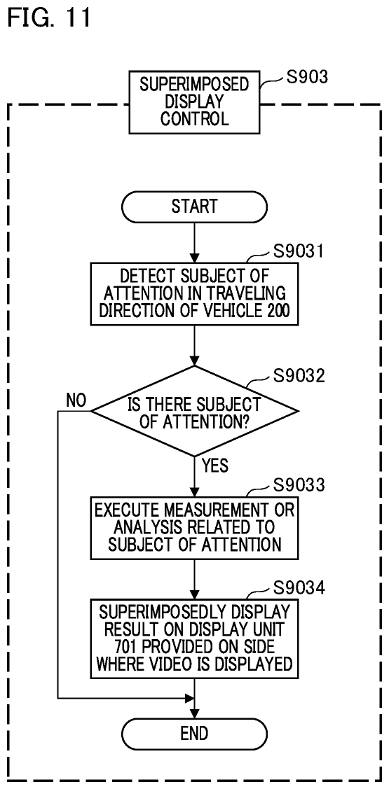

FIG. 10A to FIG. 11 are flowcharts illustrating an operation process of the vehicle-mounted display device of Example 2. FIG. 10A shows an operation process of the entirety of the vehicle-mounted display device. S901 to S903 are the same as S401 to S403 of FIG. 4A.

FIG. 10B shows an example of video display control in S902 of FIG. 10A. In S9021, the imaging unit 702 captures an image of a region in a lateral direction of the vehicle 200 to acquire a video. Subsequently, in S9022, the arithmetic operation unit 103 analyzes the video acquired in S9021, and executes a process of detecting a blink of the direction indicator of the vehicle 801 (FIG. 9). The arithmetic operation unit 103 detects a blink of the direction indicator using, for example, learned data stored in the storage unit 104. A method of detecting a blink of the direction indicator is not limited to the method of using learned data.

Next, in S9023, the arithmetic operation unit 103 determines whether the direction indicator of the vehicle 801 is blinking on the basis of the result of the detection process in S9022. If the direction indicator of the vehicle 801 is not blinking, the process ends. If the direction indicator of the vehicle 801 is blinking, it means that the driver of the vehicle 801 intends to cause the vehicle 200 to turn left. Therefore, in this case, the process proceeds to S9024.

Next, in S9024, the imaging unit 101 captures an image of a region in front of the vehicle 200 to acquire a video. In S9025, the arithmetic operation unit 103 starts to display the video on the display unit 701 provided, placed, positioned, located, or disposed on the side where the vehicle 801 is located. Meanwhile, similarly to Example 1, the display of the video on the display unit 701 may be started or ended depending on whether there is a subject of attention in the video acquired in S9024. The subject of attention is the same as that in Example 1, and is, for example, a vehicle preceding the vehicle 200, an oncoming vehicle, a pedestrian, a point of intersection, a traffic light, or the like.

FIG. 11 is a flowchart illustrating an example of superimposed display control in S903 of FIG. 10A. In S9031, the arithmetic operation unit 103 executes a process of detecting a subject of attention in the traveling direction of the vehicle 200 from the video obtained by image capturing performed by the imaging unit 101. A method of detecting a subject of attention is the same as that in Example 1. Subsequently, the arithmetic operation unit 103 determines whether the subject of attention has been detected. If the subject of attention is not detected, the process ends. If the subject of attention has been detected, the process proceeds to S9033 and the subsequent steps, and the measurement result or the analysis result of the subject is superimposed on the video obtained by the imaging unit 101 and is displayed on the display unit 701. In S9033, similarly to Example 1, the arithmetic operation unit 103 executes measurement or analysis related to the subject of attention. For example, the arithmetic operation unit 103 analyzes whether there is a traffic jam in front, measures the speed of the vehicle preceding the vehicle 200, analyzes whether there is a pedestrian in front, or the like. A target of measurement or analysis may be arbitrarily set in accordance with a situation that can be assumed. In S9034, the arithmetic operation unit 103 displays (superimposedly displays) the measurement result or the analysis result related to the subject of attention obtained in S9034 on the display unit 701 having displayed the video. Thereby, since the vehicle 801 can wait without starting, for example, a left turn, the vehicle can avoid the risk of a red signal being turned on while entering the point of intersection.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. The arithmetic operation unit 103, ay be implemented by such computer or processor.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-072257, filed Apr. 14, 2020, which is hereby incorporated by reference wherein in its entirety.

What is claimed is:

1. An image processing device in a moving object, comprising
at least one processor and a memory holding a program which makes the processor function as:
a display control unit configured to be positioned toward an outer side of the moving object to display a video acquired by image capturing performed by an imaging unit positioned in the moving object on a display device; and
a control unit configured to control superimposed display of a measurement result or an analysis result related to a subject included in the video on the video.

2. The image processing device according to claim 1, wherein the control unit superimposedly displays distance information indicating a distance from the moving object to the subject on the video.

3. The image processing device according to claim 2, wherein the distance information is measured by a distance measuring device positioned in the moving object.

4. The image processing device according to claim 2, wherein the control unit superimposedly displays the distance information based on an amount of parallax between a plurality of images having different viewpoints on the video.

5. The image processing device according to claim 1, wherein the control unit superimposedly displays a speed of the subject on the video.

6. The image processing device according to claim 5, wherein the control unit superimposedly displays the speed of the subject on the video if the subject is a moving object that moves in the same direction as or in a direction opposite to a traveling direction of the moving object.

7. The image processing device according to claim 6, wherein the control unit calculates the speed of the subject on the basis of a change in a distance between the moving object and the subject and the speed of the moving object.

8. The image processing device according to claim 1, wherein, if a specific subject determined in advance is detected from the video, the control unit highlights the specific subject to superimposedly display the highlighted subject on the video.

9. The image processing device according to claim 8, wherein the specific subject is a person or a traffic light.

10. The image processing device according to claim 1, wherein the control unit superimposedly displays an image or dimensional information of the moving object, on the video, together with the measurement result or the analysis result related to the subject.

11. The image processing device according to claim 1, further comprising:
a first imaging unit configured to capture an image of a region in a traveling direction of the moving object to acquire the video displayed on the display device; and
a second imaging unit configured to capture an image of a region in a direction different from the traveling direction of the moving object.

12. The image processing device according to claim 11, wherein the control unit executes control for displaying of a video acquired by image capturing performed by the first imaging unit and executes control for executing the superimposed display of the measurement result or the analysis result related to the subject on the video, in accordance with an analysis result of a video acquired by image capturing performed by the first imaging unit or the second imaging unit.

13. The image processing device according to claim 12, wherein, if a blink of a direction indicator of a moving object included in the video acquired by image capturing performed by the second imaging unit is detected, the control unit controls the display device and displays the video acquired by image capturing performed by the first imaging unit.

14. The image processing device according to claim 1, wherein the display device is provided on a back or side of the moving object.

15. The image processing device according to claim 1, wherein the moving object is at least any of a vehicle, a ship, or an aircraft.

16. An imaging device provided in a moving object, comprising:
an imaging unit positioned in the moving object; and
at least one processor and a memory holding a program which makes the processor function as
a display control unit configured to be provided toward an outer side of the moving object to display a video acquired by image capturing performed by the imaging unit on a display device, and
a control unit configured to control superimposed display of a measurement result or an analysis result related to a subject included in the video on the video.

17. An image processing method executed in an image processing device in a moving object, the method comprising:
displaying a video acquired by image capturing performed by an imaging unit provided in the moving object on a display device provided toward an outer side of the moving object; and
controlling superimposed display of a measurement result or an analysis result related to a subject included in the video on the video.

18. A non-transitory recording medium storing a control program of an image processing device in a moving object causing a computer to perform a control method of the image processing device, the method comprising:
displaying a video acquired by image capturing performed by an imaging unit provided in the moving object on a display device positioned toward an outer side of the moving object; and
controlling superimposed display of a measurement result or an analysis result related to a subject included in the video on the video.
